(19) United States
(12) Patent Application Publication
(10) Pub. No.: US 2007/0257943 A1
(43) Pub. Date: Nov. 8, 2007

(54) Method for rendering color EL display and display device with improved resolution

(75) Inventors: Michael E. Miller, Honeoye Falls, NY (US); Michael J. Murdoch, Rochester, NY (US); Ronald S. Cok, Rochester, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 11/429,704

(22) Filed: May 8, 2006

(51) Int. Cl. G09G 5/02

(52) U.S. Cl. 345/694

(57) ABSTRACT

A method for rendering a full-color image onto an image display device, comprising the steps of: a) obtaining a full-color input image signal representing three or more spatially coincident color values at a plurality of different spatial locations in a two-dimensional image array; b) providing a display having a plurality of at least two colors of spatially distinct light-emitting elements arranged within a two-dimensional display array; c) providing a plurality of different rendering computations, each rendering computation capable of computing a different display drive signal value for each of the plurality of light-emitting elements depending on the color values of the full-color input image signal at two or more different spatial locations and depending on differences in the color, location, or number of light-emitting elements in the display array relative to the color, location or number of color values in the image array; d) analyzing the spatial content of the full-color input image signal to select a preferred rendering computation or combination of rendering computations from among the plurality of different rendering computations for each light-emitting element; e) employing the preferred rendering computation or combination of rendering computations to form a rendered image display drive signal, the rendered image drive signal defining a value for driving each of the light-emitting elements within the two-dimensional display array; and f) displaying the rendered image on the image display.

### FIELD OF THE INVENTION

The present invention relates to rendering color images for displays having various arrangements of light-emitting elements and, more particularly, to rendering color images with improved resolution for color electro-luminescent (EL) display devices having various layouts.

### BACKGROUND OF THE INVENTION

Flat-panel display devices, for example plasma, liquid crystal and Organic Light Emitting Diode (OLED) displays have been known for some years and are widely used in electronic devices to display information and images. Such devices employ both active-matrix and passive-matrix control schemes and can employ a plurality of colored light-emitting elements to form a full-color, pixellated display. Each pixel comprises a plurality of colored sub-pixel light-emitting elements, for example red, green, and blue. It is also known to provide color displays with four colored sub-pixels in each pixel of a full-color display to reduce power usage, for example as taught in U.S. Pat. No. 6,919,681 by Cok et al. The light-emitting elements are typically arranged in two-dimensional arrays with a row and a column address for each light-emitting element. To form an image, an input image signal is rendered to provide a drive signal that is associated with each light-emitting element to drive these light-emitting elements. In some displays, the colored light-emitting elements are formed in rows or columns of a common color; in other displays neighboring rows or columns are offset from each other. In these displays, the resolution of the display is always a critical element in the performance and usefulness of the display.

If an input image signal has a format identical to the format of the light-emitting elements of the display, it is a simple matter to render the input image signal to a display drive signal. Conventional displays have three colors, red, green, and blue, arranged in an array over the two-dimensional area of the display. If the input image signal represents image values that correspond in color and location to the light-emitting elements of the display, each signal value is shown at the corresponding location on the display, perhaps with a simple conversion to account for differences between the display luminance response curve and the input metric of the input image signal. However, in most circumstances, conventional image signals employ spatially coincident color values. Use of such an image signal with a display employing spatially distinct colored light emitting elements results in the display and image signal typically not having matching formats. Further, the number and color of light-emitting elements may not correspond directly to the number and separate colors for the values in the image signal. For example, the display and image signal will not have matching formats if the image signal is a three-color signal and the display is a four-color display, as noted above, or if the resolution of the image signal does not match the resolution of the display. In these circumstances, the image signal must be spatially rendered, or transformed to a signal appropriate to the display on which the image is to be shown, as described for example in U.S. Pat. No. 6,885,380 and U.S. Pat. 6,897,876. The resolution of the display specifies the quantity of information that can be usefully shown on the display and the quantity of information directly impacts the usefulness of the electronic devices that employ the display. Moreover, the sharpness of the image displayed is also a critical factor in the usefulness of the display and can be modified through the rendering process. Hence, there is a need to optimize the rendering process for image signals that do not match the displays on which the image is to be shown.

The term “resolution” is often used or misused to represent any number of quantities. Common misuses of the term include a reference to the number of light-emitting elements or to the number of full-color groupings of light-emitting elements (typically referred to as pixels) as the “resolution” of the display. This number of light-emitting elements is more appropriately referred to as the addressability of the display. Within this document, we will use the term “addressability” to refer to the number of light-emitting elements per unit area of the display device or to the number of spatial locations represented in the input image signal. A more appropriate definition of resolution is to define the size of the smallest element that can be displayed with fidelity on the display. One method of measuring this quantity is to display the narrowest possible, neutral (e.g., white) horizontal or vertical line on a display and to measure the width of this line, or to display an alternating array of neutral and black lines on a display and to measure the period of the smallest alternating pattern having a minimum contrast. Note that using these definitions, as the number of light-emitting elements increases within a given display area, the addressability of the display will increase while the resolution, using this definition, generally decreases. Therefore, counter to the common use of the term “resolution”, the quality of the display is generally improved as the resolution becomes finer in pitch or smaller.

The term “apparent resolution” refers to the perceived resolution of the display as viewed by the user. Although methods for measuring the physical resolution of the display device are typically designed to correlate with apparent resolution, it is important to note that this does not always occur. At least two important conditions exist under which the physical measurement of the display device does not correlate with apparent resolution. The first of these occur when the physical resolution of the display device is small enough that the human visual system is unable to resolve further changes in physical resolution (i.e., the apparent resolution of the display becomes eye-limited). The second condition occurs when the measurement of the physical resolution of the display is performed for only the luminance channel but not performed for resolution of the color information while the display actually has a different resolution within each color channel.

Addressability in most flat-panel displays, especially active-matrix displays, is limited by the need to provide signal busses and electronic control elements in the display. Further, in EL displays, the electronic control elements can be required to share the area that is required for light emission. In these technologies, the more such busses and control elements that are needed, the less area in the display is available for actual light-emitting areas. Further, in such display devices, as the light-emitting area is decreased, the current density required across the EL stack to produce a desired luminance increases and this increase in current density is known to reduce the lifetime of the display device. Therefore, it is important to maintain as large a light-emitting area as possible. Regardless of whether the area required for patterning busses and control elements compete with the light-emitting area of the display, the decrease in buss and control element size that occurs with increases in addressability for a given display generally requires more accurate, and therefore more complex, manufacturing processes and can result in greater numbers of defective panels, decreasing yield rate and increasing the cost of marketable displays. Therefore, from a cost and manufacturing complexity point of view, it is generally advantageous to be able to provide a display with lower addressability. This desire is, of course, in conflict with the need to provide higher apparent resolution. Therefore, it is desirable to provide a display with relatively low addessability but high apparent resolution.

It should also be noted that other important performance attributes of the EL display device may be influenced by arrangements of light-emitting elements; including the power of the display device and the peak current that any power line within an active matrix EL display needs to deliver to the light-emitting elements to which it provides power. For example, by including white light-emitting elements or broadband light-emitting elements, especially when employing color filters to form RGB light-emitting elements, the power consumption and the current requirements for a typical EL display device can be reduced significantly, as described in US 2004/0113875 and US 2005/0212728, both entitled “Color OLED display with improved power efficiency”. The use of such arrangements of light-emitting elements can be employed with drive circuitry as described by U.S. Pat. No. 6,771,028, entitled “Drive circuitry for four-color organic light-emitting device” which discloses several simplified driving means for such arrangements of light-emitting elements. These include, for example, pairs of columns of light-emitting elements, each pair of columns containing four-colors of organic light-emitting devices which share a common electrical bus. The fact that pairs of columns of light-emitting elements share this electrical bus reduces the area required for electrical bus structures by reducing the number of buses and therefore the area between electrical buses. It is also important to note that when such broad band light-emitting elements are employed, these light-emitting elements will emit light nearer the center of the human photopic sensitivity curve than red and blue light-emitting elements and will therefore be perceived as being high luminance light-emitting elements.

It has been known for many years that the human eye is more sensitive to luminance in a scene than to chrominance. Current understanding of the human visual system suggests processing is performed within or near the retina of the human eye, wherein such processing converts the signal that is generated by the photoreceptors into a luminance signal, a red/green chrominance difference signal and a blue/yellow chrominance difference signal. Each of these three signals have different resolution as depicted by the contrast threshold curves shown in FIG. 1 for a given user population and illumination level. As shown, the luminance channel can resolve the finest detail as indicated by the fact that the contrast threshold curve for the luminance signal 2 has the highest spatial frequency cutoff (i.e., the maximum spatial frequency the eye can resolve at a Michelson contrast of 1 is significantly higher than for the color channels). The contrast threshold for the red/green signal 4 has the second highest spatial frequency cutoff, which is on the order of one half the cutoff for the luminance signal, and the blue/yellow signal 6 has the lowest spatial frequency cutoff.

This difference in sensitivity is well appreciated within the imaging industry and has been employed to provide lower cost systems with high perceived quality within many domains, most notably digital camera sensors and image compression and transmission algorithms. For example, since green light provides the preponderance of luminance information in typical viewing environments because the human visual systems are significantly more sensitive to green light than to red or blue light, digital cameras typically employ two green sensitive elements for every red and blue sensitive element and interpolate intermediate luminance values for the missing colored elements within each color plane as described in U.S. Pat. No. 3,971,065, entitled “Color imaging array”. In typical image compression and transmission algorithms, image signals are converted to a luminance/chrominance representation and the chrominance channels undergo significantly more compression than the luminance channel.

The relative sensitivities of the human eye to different color channels have recently been used in the liquid crystal display (LCD) art to produce displays having subpixels with broad band emission to increase perceived resolution. For example, US Patent Application 2005/0225574 and US Patent Application 2005/0225575, each entitled “Novel subpixel layouts and arrangements for high brightness displays” provide various subpixel arrangements such as the one shown in FIG. 2. FIG. 2 shows a portion of a prior art display 10 as discussed within these disclosures. Of importance in this subpixel arrangement is the existence of a high-luminance (often white or cyan) subpixel 12 that allows more of the white light generated by the LCD backlight to be transmitted to the user than the traditional RGB subpixels (14, 16, and 18) and the fact that each row in the subpixel arrangement contains all colors of subpixels, makes it possible to produce a line of any color using only one row of subpixels. Similarly, every pair of columns within the subpixel arrangement contain all colors of subpixels within the display, making it possible to produce a line of any color using only two columns of subpixels. Therefore, if the LCD is driven correctly, it can be argued that the vertical resolution of the device is equal to the height of one row of subpixels and the horizontal resolution of the device is equal to the width of two columns of subpixels, even though it realistically requires more subpixels than the two subpixels at the intersection of such horizontal and vertical lines to produce a full-color image. However, since each pair of subpixels at the junction of such horizontal and vertical lines contain at least one high luminance subpixel (typically green 16 or white 12), each pair of light-emitting elements provide a relatively accurate luminance signal within each pair of subpixels, providing a high-resolution luminance signal.

The drive scheme for such a display is discussed in more detail within US Patent Application 2005/0225563, entitled “Subpixel rendering filters for high brightness subpixel layouts”. As this drive scheme was developed for use in LCD displays, the power consumption of the display is controlled primarily by the backlight brightness, and the addition of broad band subpixels (white, cyan, or yellow) only increase the output luminance of the display device when the light they transmit is used to augment (i.e., is added to) the light that is produced for the RGB subpixels. Therefore, the algorithms that are provided within US Patent Application 2005/0225563 utilizes all colors of subpixels within the display device as much as possible without producing excessive color errors during color rendering. This drive scheme is not desirable for use in an EL display employing a more efficient fourth emitter in combination with RGB emitters, where the maximum efficiency gains that can be achieved are arrived at by turning off the less efficient, narrow transmission band RGB light-emitting elements as much as possible. The image processing path that is employed in US Patent Application 2005/0225563 involves blurring and sharpening kernels that are employed when rendering data to each light-emitting element, irrespective of the type of image feature that it represents. These kernels allow the localized color error that might be present between the image represented in the input image signal and the image that is displayed by any two subpixels on the display device to be spread by a fixed proportion to all of the neighboring subpixels, often resulting in blurring of edges or of small image features and, therefore, less than optimal apparent display resolution. In fact, the method will often employ a compromised set of blur and sharpening kernels that provide adequate blur to prevent the appearance of jagged edges or dark areas within the displayed image but that blur the edges of the image features to within some acceptable level.

More desirable methods for driving an EL displays have been discussed in U.S. Pat. Nos. 6,885,380 and 6,897,876, both entitled “Method for transforming three colors input signals to four or more output signals for a color display” to achieve higher display efficiency. These methods allow neutral content to be displayed using only the broadband light-emitting elements. Application of these algorithms designed for obtaining maximum power advantages to an image input signal together with arrangements of light-emitting elements as described in US Patent Application 2005/0225574 and US Patent Application 2005/0225575 would result in the pixel patterns not employing the green high-luminance light-emitting element to allow pairs of light-emitting elements to render a high-resolution image, and therefore would not provide improved image quality. U.S. Pat. No. 6,897,876 describes a method for adjusting the use of light-emitting elements near edges within the image signal on a display employing RGBW stripe patterns, however, a method for using this algorithm to optimize the apparent resolution and display power consumption in conjunction with pixel patterns such as illustrated in FIG. 2 is not provided. In fact, application of these algorithms to an image input signal to improve the perceived resolution will significantly increase the power consumption of the display.

It is also known to provide an EL display device having pixels with differently sized light-emitting elements, wherein the relative sizes of the elements in a pixel are selected to extend the service life of the display as discussed by U.S. Pat. No. 6,366,025, entitled “Electroluminescence display apparatus”. In particular, larger areas of white emitting elements as described in US2004/0113875 may be desirable. Further, such a pixel arrangement would ideally minimize the peak current along an electrical bus within the EL display, increasing the practical aperture ratio of the display device and therefore extending the lifetime of the display device.

As described above, a variety of image rendering schemes have been proposed for optimizing various attributes of a display. However, such schemes as are known in the prior art may not simultaneously optimize the power usage, color, and apparent resolution of OLED displays, particularly for OLED displays having light-emitting elements that emit four or more colors. There is a need, therefore, for an improved rendering process for images on OLED displays.

### SUMMARY OF THE INVENTION

In accordance with one embodiment, the invention is directed towards a method for rendering a full-color image onto an image display device, comprising the steps of: a) obtaining a full-color input image signal representing three or more spatially coincident color values at a plurality of different spatial locations in a two-dimensional image array; b) providing a display having a plurality of at least two colors of spatially distinct light-emitting elements arranged within a two-dimensional display array; c) providing a plurality of different rendering computations, each rendering computation capable of computing a different display drive signal value for each of the plurality of light-emitting elements depending on the color values of the full-color input image signal at two or more different spatial locations and depending on differences in the color, location, or number of light-emitting elements in the display array relative to the color, location or number of color values in the image array; d) analyzing the spatial content of the full-color input image signal to select a preferred rendering computation or combination of rendering computations from among the plurality of different rendering computations for each light-emitting element; e) employing the preferred rendering computation or combination of rendering computations to form a rendered image display drive signal, the rendered image drive signal defining a value for driving each of the light-emitting elements within the two-dimensional display array; and f) displaying the rendered image on the image display.

### Advantages

The advantages of various embodiment of this invention include providing a color display device with improved apparent resolution, with reduced power consumption and/or extended lifetime.

### BRIEF DESCRIPTION OF THE DRAWINGS

FIG. 1 is a graph depicting the human contrast threshold for luminance and chrominance information (prior art);

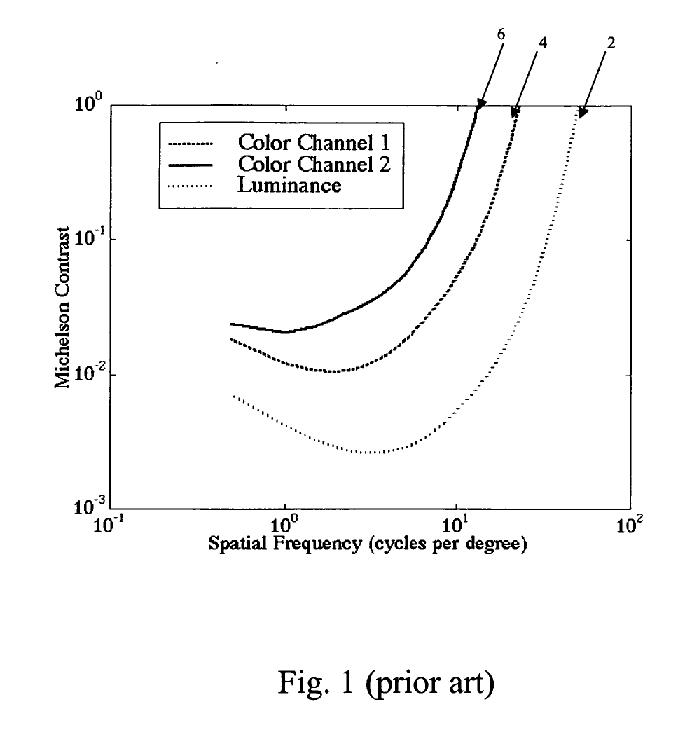

FIG. 2 is a schematic diagram showing the relative arrangement of subpixels within a prior art liquid crystal display disclosure;

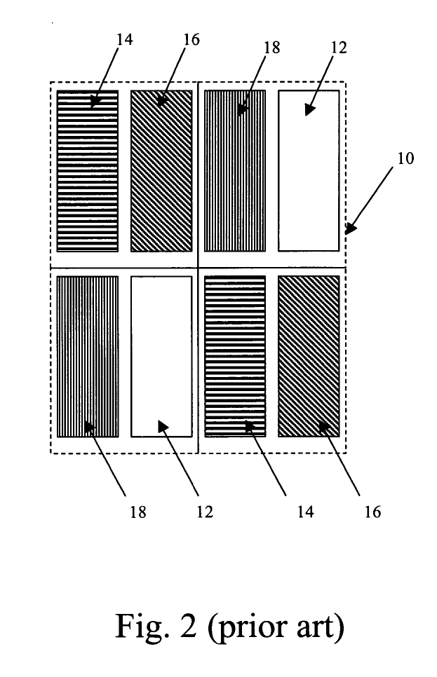

FIG. 3 is a schematic diagram of a portion of an EL display having red, green, blue and white light-emitting display useful in practicing the present invention;

FIG. 4 is a schematic diagram depicting the vertical cross section of a light-emitting element in an EL display useful in practicing the present invention;

FIG. 5 is a diagram depicting the components of a display in accordance with an embodiment of the present invention;

FIG. 6 is a flow diagram depicting the processing steps that a controller may perform to enable an embodiment of the present invention;

FIG. 7 is a depiction of a portion of an EL display having the arrangement of light-emitting elements as shown in FIG. 3 when rendered using a controller in accordance with an embodiment of the present invention;

FIG. 8 is a schematic diagram of an alternative arrangement of light-emitting elements useful in practicing an embodiment of the present invention, wherein the light-emitting elements include, red, green, blue, white, and an additional colored light-emitting element;

FIG. 9 is a schematic diagram of an alternative arrangement of light-emitting elements useful in practicing an embodiment of the present invention, wherein the light-emitting elements include red, green, blue, yellow and cyan light-emitting elements;

FIG. 10 is a schematic diagram of an alternative arrangement of light-emitting elements useful in practicing an embodiment of the present invention, wherein the light-emitting elements includes an equal number and area of red, green, and blue light-emitting elements together with a larger number and area of white light-emitting; and

FIG. 11 is a schematic diagram representing a two-dimensional array of light-emitting elements displaying a flat field image;

FIG. 12 is a schematic diagram representing a two-dimensional array of light-emitting elements displaying an image containing a vertical edge;

FIG. 13 is a schematic diagram representing a two-dimensional array of light-emitting elements displaying an image containing a diagonal line;

FIG. 14 is a flow diagram depicting the processing steps that a controller may perform to enable the present invention; and

FIG. 15 is a representation of an image signal comprising three arrays of spatially coincident color values, each color array illustrated in a different plane;

FIG. 16 is a schematic diagram of four color light-emitting elements arranged in columns and displaying a white, diagonal line; and

FIG. 17 is a schematic diagram of four color light-emitting elements arranged in columns and displaying a thick, white, diagonal line.

### DETAILED DESCRIPTION OF THE INVENTION

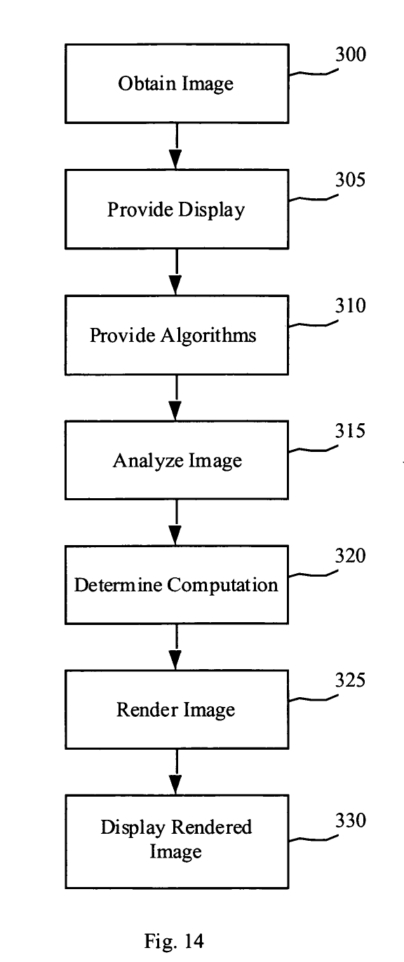

Referring to FIG. 14, a method for rendering a full-color image onto an image display device, comprises the steps of obtaining 300 a full-color input image signal representing three or more spatially coincident color values at a plurality of different spatial locations in a two-dimensional image array; providing 305 a display having a plurality of at least two colors of spatially distinct light-emitting elements arranged within a two-dimensional display array; providing 310 a plurality of different rendering computations, each rendering computation capable of computing a different display drive signal value for each of the plurality of light-emitting elements depending on the color values of the full-color input image signal at two or more different spatial locations and depending on differences in the color, location, or number of light-emitting elements in the display array relative to the color, location or number of color values in the image array; analyzing 315 the spatial content of the full-color input image signal to select 320 a preferred rendering computation or combination of rendering computations from among the plurality of different rendering computations for each light-emitting element; employing 325 the preferred rendering computation or combination of rendering computations to form a rendered image display drive signal, each value in the rendered image drive signal defining a value for driving each of the light-emitting elements within the two-dimensional display array; and displaying 330 the rendered image on the image display. In one embodiment of the present invention, the two or more spatial locations of the full-color image are neighboring locations and may represent the color values in a local region of the full-color image.

As used herein, a rendering computation converts an image specification (typically three spatially coincident color values in an ordered two-dimensional array) to a signal suitable for driving a specific display device having an array of light-emitting elements. In general, the image array will not match the spatial arrangement of the light-emitting elements in the display device where the image array employs color planes having spatially coincident values while the display has spatially distinct locations for each colored light-emitting element. Thus, the color values in an image signal all represent values at a single spatial location while the display emits different colored light at different, distinct, spatial locations. In this case, the display array will have differences in the color, location, or number of light-emitting elements relative to the color, location or number of color values in the image array. Hence, any useful rendering computation must accommodate both the image array and the display array to calculate a signal for driving the display to show the color image to best effect. Also, as used herein, a computation is a mathematical transformation of values into different, or the same, values. An algorithm requires the use of a decision as to what computation is desired. The present invention contemplates an analysis of an input image signal to understand the image content at a plurality of localized image regions relative to the color and location of light-emitting elements in a corresponding display region to determine and select a preferred rendering computation or combination of rendering computations from among a plurality of provided rendering computations to transform an input image signal into a rendered image signal suitable for driving the display.

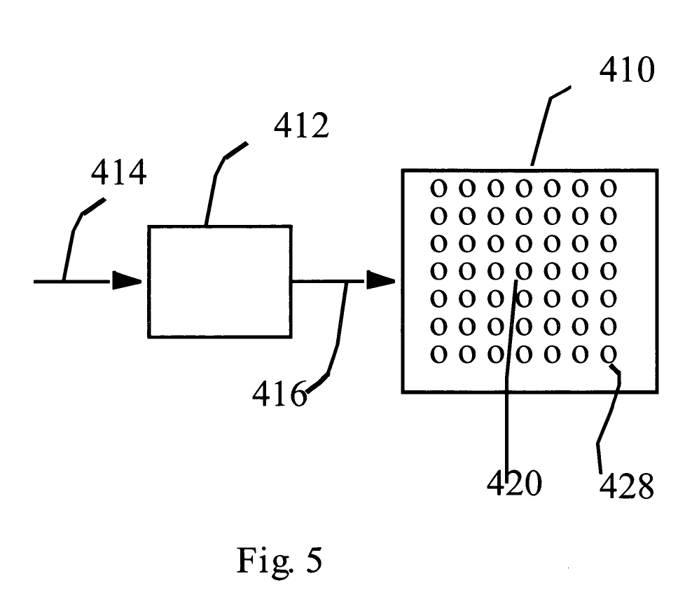

Referring to FIG. 5, a display device may comprise a display 410 having a plurality of at least two colors of light-emitting elements 428 arranged within a two-dimensional array, and a controller 412 for computing a plurality of rendering computations, receiving an input image signal 414, analyzing the input image signal to determine a preferred rendering computation, rendering the image with the determined preferred rendering computation, and displaying the rendered image 416 on the display 410.

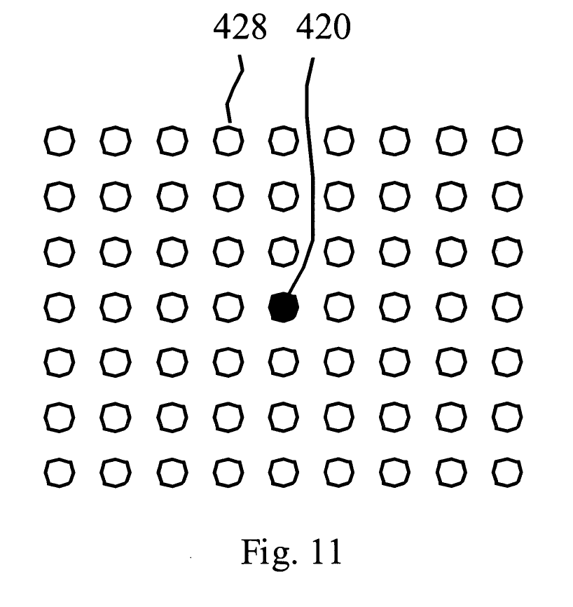

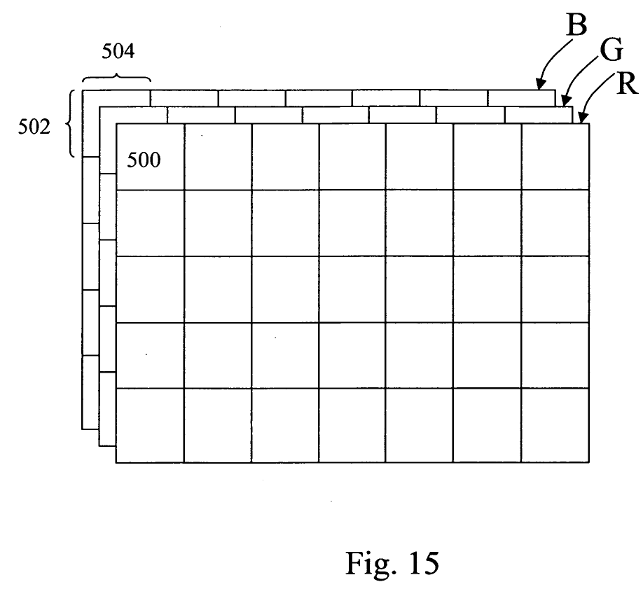

Referring to FIG. 15, the input image signal 414 typically is comprised of data values representing three spatially coincident color planes, such as red R, green G, and blue B at various locations 500 in a two-dimensional space. FIG. 15 shows thirty spatial locations, including five rows 502 and six columns 504 of spatial locations wherein the rows 502 and columns 504 are orthogonal and thus form a two-dimensional grid of spatial locations 500. This input image signal may represent images having various content. For example, a spatial region that is represented by the two-dimensional image signal, might include a flat field defined by input image signal values that are substantially equal within a local, two-dimensional array and that are intended to appear to a user as a region that is uniform in luminance and color. If such a flat field is detected, a preferred rendering computation may be determined that, for example, maintains the overall luminance and chrominance of the field and minimizes any undesirable high frequency spatial component in the image. Alternatively, a preferred rendering computation that minimizes unwanted low-frequency color error may be preferred or included. Such an example is depicted in FIG. 11, wherein a rendered image value is to be computed for a light-emitting element 420 that will depict the image at a spatial location of the display corresponding to the spatial location of a data value in the input image signal. In this example, the input image-signal values corresponding to the region around element 420, i.e., corresponding to elements 428, all share approximately the same input image signal values as the input image signal data value corresponding to element 420. As such, the preferred rendering computation would minimize unwanted high frequency luminance or low frequency chrominance variation.

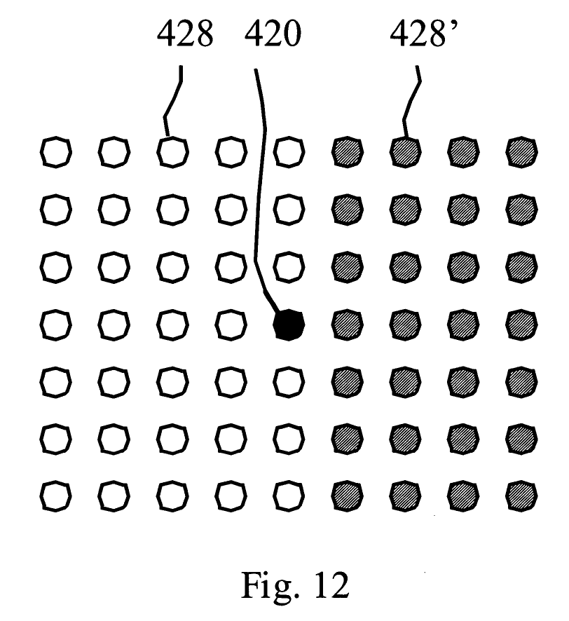

Alternatively, the input image signal may represent a spatial region in which the spatial locations in the input image signal represent at least a part of a luminance and/or a chrominance edge, wherein this edge defines first and second image areas having a distinctive difference in luminance or chrominance as is depicted in FIG. 12. Such an edge is defined by the juxtaposition of two dissimilar areas, the light-emitting elements in each area having substantially common attributes, for example common patterns or flat fields. As shown in FIG. 12, a flat field comprising light-emitting elements 428 having a substantially common color and luminance is separated along an edge from a flat field comprising light-emitting elements 428′ having a different substantially common color and luminance. Such an edge may be a horizontal, a vertical, or a diagonal edge. If such an edge is found, the preferred rendering computation may provide a different rendering for light-emitting elements in the first image area than the computation for light-emitting elements in the second image area. For example, if the first image area has a first color or luminance and the second image area has a second color or luminance, the preferred rendering computation may modify the rendered image signal of the first color or luminance in the first area differently from the second color or luminance in the second area. In a specific example, any luminance or chrominance error that is presented at a localized area within the array of light-emitting elements may be compensated by differentially diffusing this error by adding light preferentially to the rendered image signal for the light-emitting elements on the side of the edge having a higher luminance or chrominance signal and/or by subtracting light preferentially from the rendered image signal for the light-emitting elements on the side of the edge having a lower luminance or chrominance signal.

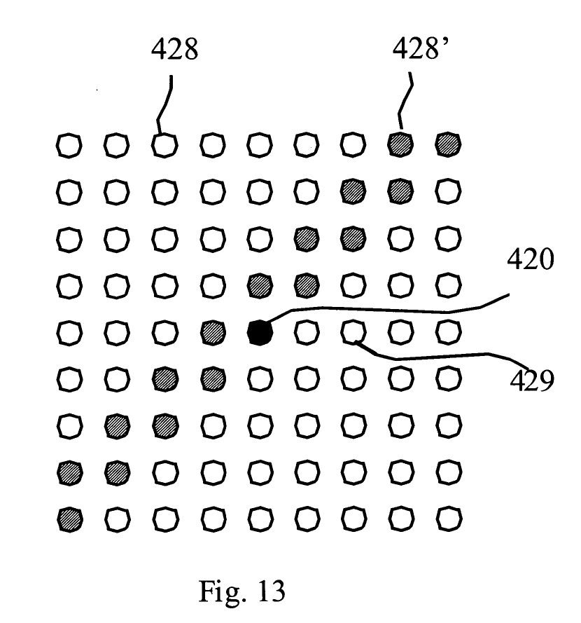

Referring to FIG. 13, the input image signal may further represent a spatial region of an image in which the spatial locations in the input image signal represents at least a part of a luminance and/or a chrominance line which divides a first spatial area from a second spatial area. The first and second areas may, or may not, have a common pattern of input image signal values. The input image signal values representing the line 428′ will, however, have different values than the input image signal values on at least one side of the line. Such a line may be a horizontal, a vertical, or, as shown, a diagonal line. In this alternative embodiment, the preferred rendering computation may provide a different rendering for light-emitting elements 428 in the first image area than the rendering for light-emitting elements 429 in the second image area and may further employ another rendering computation for light-emitting elements that are used to represent the input image signal values that comprise the line 428′, such as 420. The analysis may alternatively or additionally determine whether a light-emitting element forms part of a random field having a range of output values and a rendering computation chosen appropriately. Finally, the analysis may produce values that indicate the strength or probability of a rendered image value representing a portion of any of these types of spatial arrangements within the input image signal.

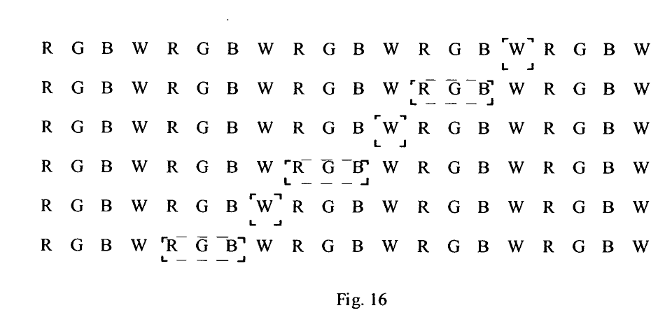

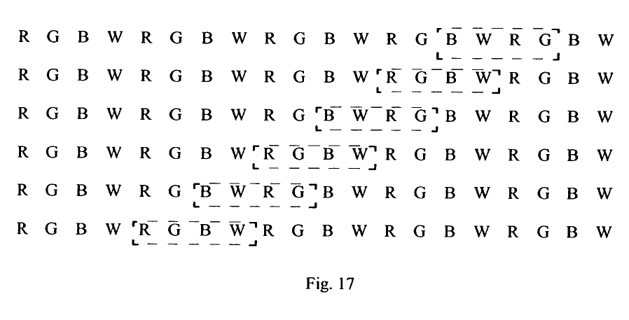

Referring to FIGS. 16 and 17, examples of FIG. 13 are described in more detail for a particular embodiment of a display having red, green, blue, and white light-emitting elements arranged in columns. Referring to FIG. 16, a diagonal white line may be rendered differently for different light-emitting elements depending on the full-color input image signal at the spatial locations neighboring the white line and depending on the color and location of the light-emitting elements in the display array. In this case, the objective is to smoothly render the diagonal, white line with as high a color fidelity and resolution as possible. In a conventional rendering, the white elements W or the color elements RGB alone would be employed in successive lines, or the same aligned sequences of elements RGBW, thereby forming a jagged line. By employing an alternative rendering wherein the use of a white light-emitting element W is alternated with the use of three neighboring color elements RGB (indicated with the dashed rectangles), the color fidelity may be maintained while the jagged edges of the line are reduced, improving the smoothness of the line. In an alternative rendering example shown in FIG. 17, a thicker, diagonal white line may be displayed by employing different sequenced groups of the four light-emitting elements in each successive row (indicated with the dashed rectangles), thereby maintaining the color and thickness of the line, and providing improved smoothness.

The present invention may be employed with a variety of image and display types. In one embodiment, the image may define red, green, or blue color values and the display may include colors of light-emitting elements comprising red, green, and blue. Alternative displays may comprise colors of light-emitting elements including at least four colors. For example, the colors of light-emitting elements may comprise red, green, and blue light-emitting elements and a second green, a yellow, a cyan, a magenta, a broadband, or a white light-emitting element. The multiple light-emitting elements may be arranged to form a spatial arrangement that is substantially square, and neighboring substantially square spatial arrangements of light-emitting elements may comprise different colors of light-emitting elements. The light-emitting elements may be arranged substantially into orthogonal rows and columns, and wherein at least one of the rows or columns contain all colors of light-emitting elements and wherein multiple colors of light-emitting elements are also present within the orthogonal columns or rows.

In various embodiments of the present invention, the number of image elements may be different in the image and the display. For example, the number of two-dimensional spatial locations within the full-color input image signal may be larger than the number of at least one of the colors of light-emitting elements within the display. Alternatively, the number of two-dimensional spatial locations within the full-color input image signal may be larger than the number of each color of light-emitting elements within the display.

In general, according to the present invention, the selection of a preferred rendering computation may include analyzing the two-dimensional spatial content of the full-color input image signal. The spatial content refers to the location of the color values in the input image signal, but also may include the brightness and color values at each spatial location. It is possible, and may be preferred, to provide different rendering computations at different brightness levels or in areas of substantially different color or luminance frequency. Additionally, a different rendering may be employed for light-emitting elements in an edge or in the vicinity of an edge between first and second image areas than is employed for light-emitting elements in at least one of the first or second image areas. Edges may, for example, be horizontal, vertical, or diagonal. Hence, a different preferred rendering computation may be employed depending on these factors at a specific light-emitting element display location or the local area surrounding the light-emitting element. In general, at a high resolution or large viewing distance it is preferred that any rendering computation maintain the average brightness of the display at each brightness level, since the eye is very sensitive to changes in brightness over a small spatial extent. However, for some signal types, having edges for example, a large-scale change in brightness in one portion of the image is contrasted with another portion and a different rendering computation may be preferred.

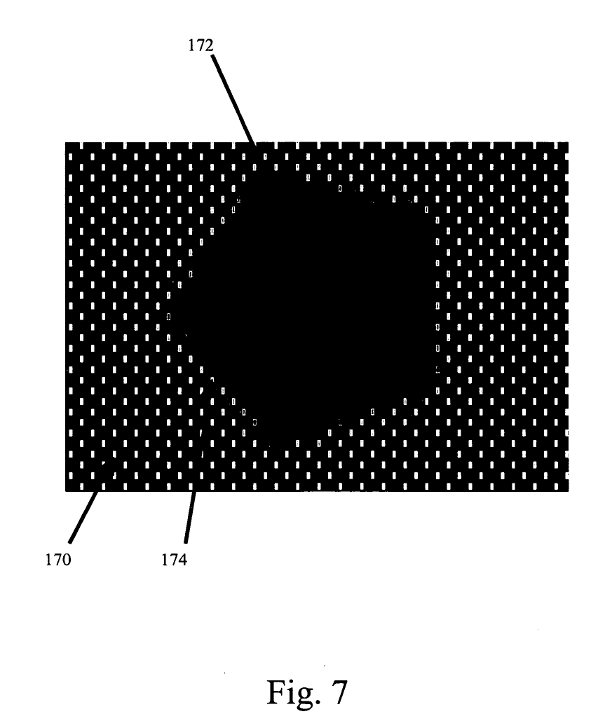

According to the present invention, the colors of spatially distinct light-emitting elements may include at least three different colors and an additional color within the gamut defined by the three different colors. Where the additional color light-emitting element is more energy efficient than at least one of the gamut-defining light-emitting elements, the preferred rendering computation may adjust the ratio of the sum of the luminance values of the gamut-defining color light-emitting elements to the sum of the luminance values of the additional light-emitting elements for light-emitting elements in the vicinity of an edge between first and second image areas such that the ratio is closer to one than the ratio of the sum of the luminance values of the gamut-defining color light-emitting elements to the sum of the luminance values of the additional light-emitting elements for light-emitting elements within the interior of at least one of the first and second image areas within the displayed image, thereby increasing apparent display resolution while providing increased display power efficiency. Such embodiment is further discussed below in relation to FIG. 7.

A variety of computational means may be employed to analyze the image content to determine a preferred rendering computation. For example, convolution, correlation, pattern matching, frequency transforms, morphological processing, edge detection, image feature extraction, image segmentation, shape analysis, statistical analysis, and a priori information concerning image content, structure or attributes may all be used. Similarly, a wide variety of computations may be employed to render an image. The choice of computation will depend on the nature of the image content and the nature of the display and application. In particular, the resolution and anticipated viewing distance may be used to determine the type of rendering provided. For example, at a relatively large resolution or anticipated large viewing distance, the spatial extent of the image signal compensation may be larger while at a relatively fine resolution or a near viewing distance, the spatial extent may be reduced. Computational methods for rendering may include matrix transformations, convolutions, correlations, contrast manipulation, histogram modification, noise cleaning, color modification, spatial filtering including sharpening and blurring, image restoration, and geometrical image modifications. Such techniques are known in the art and described, for example, in the book “Digital Image Processing” by William K. Pratt, published by John Wiley and Sons, 1991. In accordance with the invention, upon analysis of the input image signal spatial content, a preferred rendering computation may be locally applied.

Images may be rendered for a variety of displays using the present invention, including liquid crystal displays, organic light-emitting diode displays, and plasma displays. Suitable control and processing devices may be implemented using digital computing circuitry using, for example, integrated circuit technology using memories, adders, multipliers, accumulators, etc., as are known in the art. In particular digital signal processors are commercially available and may be integrated into a controller or employed as a separate device.

According to the present invention, the light-emitting elements will generally be formed in rows or columns to enable a simple and low-cost manufacturing process. In one preferred embodiment, the light-emitting elements are formed in ordered stripes of red, green, blue, and white light-emitting elements, providing a simple layout and good image quality, particularly for graphics and text. Alternatively, two-by-two quad patterns may be employed for four light-emitting elements. The light-emitting elements may be under active-matrix or passive-matrix control, as is known in the art. The formation of light-emitting elements employing patterned emitters or color filters with unpatterned white emitters is known in the art.

Although the description of the present invention is described above with light-emitting elements formed in rows and columns, by rotating the display 90 degrees the rows can be exchanged with columns. Hence, the light-emitting elements can be considered to be formed in rows or columns and the present invention includes both embodiments.

The light-emitting element arrangements illustrated in the figures are examples only. It is possible, within the present invention, to re-order the light-emitting elements to change the visual characteristics of the display, for example by locating a white light-emitting element immediately adjacent to a green light-emitting element. Alternatively, multiple, identical light-emitting elements (for example repeated white or green light-emitting elements) may be employed while other light-emitting elements (for example red or blue) may be sampled less frequently. Such arrangements may optimize the luminance of the display or take advantage of the human visual system's decreased response to color non-uniformities.

In a simple example of an embodiment of the present invention, an image may contain a flat, gray or white field and a display may include four colors, red, green, blue, and white. A preferred rendering computation for this example may include maximizing the uniformity of the flat field by employing all four light-emitting elements in concert, including the white light-emitting element and equal amounts of light from each of the red, green, and blue light-emitting elements. Such a rendering computation will cause the display to emit light from every spatial location on the surface, thereby maximizing the uniformity of the display. In a contrasting example, a color image may contain high-frequency signals. In this case, a white color value in the image may be rendered by employing the white light-emitting element in the display alone. If the white light-emitting element is more efficient than the color elements, such a rendering computation will result in energy savings without compromising the quality of the image since a viewer may not be able to distinguish the higher spatial frequencies resulting from employing one light-emitting element while other light-emitting elements are not lit.

In an alternative example employing a color image containing high-frequency signals, the image may be rendered by employing pairs of light-emitting elements emitting light of different colors to reproduce the luminance signal while employing error diffusion to correct for color errors resulting from attempting to reproduce a complete color value with only two different colors. Because of the high-frequency content, the color error may not be perceptible while the increased luminance frequencies will give the appearance of a higher resolution display. Such rendering techniques are described in more detail in concurrently filed, co-pending, commonly assigned U.S. Ser. No. ______ (Kodak Docket 92016), the disclosure of which is hereby incorporated in its entirety by reference.

In other embodiments of the present invention, the preferred rendering computation may provide a different rendering for light-emitting elements on an edge or in the vicinity of the edge between first and second image areas than for light-emitting elements in at least one of the first or second image areas. Alternatively, the preferred rendering computation may provide a different rendering for light-emitting element in a line between first and second image areas than the rendering for light-emitting elements in the first or second image areas. For example, if a four-color display has light-emitting elements emitting light of a common color arranged in columns (stripe configuration) and a diagonal edge passes through a group of four light-emitting elements in a row, it may be possible to render the image in such a way as to improve the resolution of the edge. If the edge separates a red field from a blue field and the red light-emitting element falls on the red side of the diagonal edge and the blue light-emitting element falls on the blue side of the diagonal edge, both light-emitting elements may be simultaneously employed. If the light-emitting elements fall on the other side of the edge, it may be preferred not to employ either. Likewise, if a white line passes through a row of differently colored light-emitting elements, if the white line passes through a white light-emitter, the white light-emitter may be rendered to turn on. If the white line passes through the colored emitters, the colored emitters may be employed in concert to form a white-light-emitting area. Such content-aware image rendering computations may thus improve the apparent resolution of the display while also providing power savings.

According to the present invention, a display device may comprise a plurality of at least two colors of spatially distinct light-emitting elements arranged within a two-dimensional display array; and a controller responsive to a full-color input image signal representing three or more spatially coincident color values at a plurality of different spatial locations in a two-dimensional image array, for providing a plurality of different rendering computations, each rendering computation capable of computing a different display drive signal value for each of the plurality of light-emitting elements depending on the color values of the full-color input image signal at two or more different spatial locations and depending on differences in the color, location, or number of light-emitting elements in the display array relative to the color, location or number of color values in the image array, for analyzing the spatial content of the full-color input image signal to select a preferred rendering computation or combination of rendering computations from among the plurality of different rendering computations for each light-emitting element, for employing the preferred rendering computation or combination of rendering computations to form a rendered image display drive signal, the rendered image drive signal defining a value for driving each of the light-emitting elements within the two-dimensional display array, and for driving the light-emitting elements to display the rendered image on the image display. The light-emitting elements in the display device may be arranged in groups forming a repeating two-by-two array of light-emitting elements.

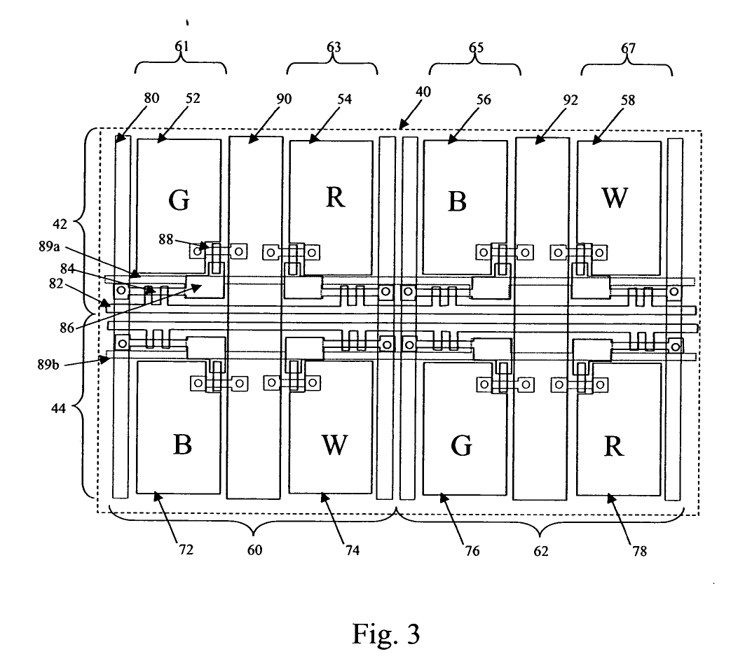

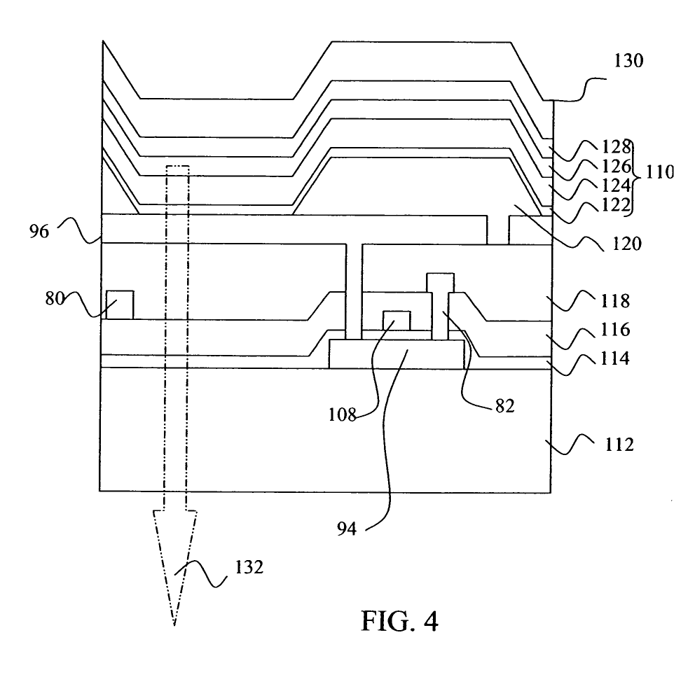

Referring to FIG. 3, in a more detailed embodiment of the present invention, a display device may be comprised of a plurality of red 54, 78, green 52, 76, and blue 56, 72 light-emitting elements, and at least one additional 58, 74 color of light-emitting element having luminance efficiency greater than at least one of the red, green and blue light-emitting elements and preferably a luminance efficiency that is greater than the average efficiencies of the red, green and blue light-emitting elements. Referring to FIG. 4, each light-emitting element includes a first electrode 96 and a second electrode 130 having one or more electro-luminescent layers 110 formed there-between, at least one electro-luminescent layer being light-emitting, at least one of the electrodes being transparent and wherein the first and second electrodes defining one or more light-emissive areas. Within this display, the light-emitting elements are laid out over a substrate in adjacent columns 61, 63, 65, 67 arranged along a first dimension and adjacent rows 42, 44 arranged along a second dimension, such that each pair 60, 62 of adjacent columns of light-emitting elements, and each row 42, 44 of light-emitting elements, contain each of the red, green, blue and additional color light-emitting elements.

This arrangement of light-emitting elements allows a luminance pattern to be created such that a white line may be created which is one pair of columns or one row height in width, thereby increasing the potential for higher perceived resolution relative to pixel patterns not employing all colors in each row or pair of columns. However, to reduce the power consumption of the electro-luminescent display while delivering this higher perceived resolution, the display system must further be comprised of a controller for receiving an input signal for an input image having a two-dimensional spatial content (i.e., having edges in two or more relative orientations) and selecting a preferred rendering computation so the input signal is render such that a four-or-more color drive signal is created to drive red, green, blue and the one or more additional light-emitting elements wherein the more efficient additional light-emitting elements are preferentially employed over the use of the red, green, and blue light-emitting elements at locations having a relatively low edge strength compared to the use of such light-emitting elements at locations having a high edge strength. This may also be expressed as requiring that the ratio of the sum of the luminance values of the red, green, blue light-emitting elements to the sum of the luminance values of the additional light-emitting elements at spatial locations having a relatively high edge strength is closer to one than the ratio of the sum of the luminance values of the red, green, blue light-emitting elements to the sum of the luminance values of the additional light-emitting elements at spatial locations having relatively lower edge strength when provided on the display. Accordingly, when the input signal that is provided to represent an input image having a two-dimensional spatial content that includes edge boundaries between first and second regions is provided to the controller, and the additional light-emitting elements may be driven at different levels in the first and second regions of the input image, and utilization of the light-emitting elements is adjusted such that the ratio of the sum of the luminance values of the red, green, blue light-emitting elements to the sum of the luminance values of the additional light-emitting elements along an edge boundary in at least one of the first and second regions is closer to one than the ratio of the sum of the luminance values of the red, green, blue light-emitting elements to the sum of the luminance values of the additional light-emitting elements within the interior of the at least one of the first and second regions within the displayed image. By providing this control, the controller allows the higher efficiency additional light-emitting element to be utilized in place of the lower efficiency red, green, or blue light-emitting elements for much of the image. However, near high luminance edges, where spatial resolution is particularly necessary, the controller utilizes all of the light-emitting elements to deliver the potential for a higher perceived resolution that is provided by the arrangement of light-emitting elements within the display.

This display system can be particularly advantaged when the light-emitting elements are rectangular in shape, having a longer first dimension than the second dimension, and the input signal that is provided has an addressability (i.e., represents a number of spatial locations) that is larger than the number of full color repeat patterns within the display device. In such a display, the length of the light-emitting elements in the first dimension preferably will be at least 1.5 times the length of the light-emitting elements in the second dimension and the length of light-emitting elements. More preferably, the length of the light-emitting elements in the first dimension will be approximately 2 times the length of the light-emitting elements in the second dimension, and the addressability of the input signal will be equal to half the number of light-emitting elements along the second dimension and equal to the number of light-emitting elements in the first direction. Although the first or second dimension may be laid out to lie on the horizontal, vertical, or any other orientation with respect to the substrate, since there are twice as many light-emitting elements in the second dimension, providing light-emitting elements which have a first dimension that is 2 times their second dimension will provide approximately equal resolution along both dimensions. It might be further recognized that while this invention can be applied for many different display configurations, it will be most valuable for high resolution displays wherein the height of a row is smaller than about 2 minutes of visual angle when viewed by a human observer at the desired or anticipated viewing distance.

This display system can be particularly advantaged when the display device is comprised of an active matrix circuit wherein power is provided by an array of electrical busses since the display will have on the order of half as many light-emitting elements as a display having a conventional pixel layout and with a comparable resolution, and therefore will require substantially fewer active matrix drive circuits than a display of comparable resolution. Additional advantages will be obtained when one or more of the electrical busses provide current to each color of light-emitting elements within the display device. For example, within the full color device each column of a pair of columns of light-emitting elements may be arranged along each side of and may be supplied power by a single electrical buss. Alternatively, pairs of rows of light-emitting elements may be arranged along each side of and may be supplied power by a single electrical buss. This arrangement provides economies by allowing pairs of rows or columns of light-emitting elements, decreasing the number of electrical buses that are required and therefore the space that is required between each of these electrical busses and other patterned elements on the substrate.

In an even more preferred embodiment, the controller may be designed to drive the light-emitting elements of the display device in combination such that the total current requirements of the busses are reduced while the power busses provide power to every color of light-emitting element (i.e., either pairs of columns, individual rows, or pairs of rows). This may be accomplished by controlling the light emissive elements such that the luminance produced by at least one of the light-emitting elements, when all colors of light-emitting elements are employed simultaneously, is lower than the luminance that is produced by the same light-emitting element when the color of light that is being displayed is approximately equal to the color of the light-emitting element. When the light-emitting element is a white light-emitting element, this drive scheme reduces the peak current that each buss is required to provide to a peak current that is on the order of the peak current required to drive two of the four light-emitting elements, reducing the area of the required buss by a factor of a one-half and providing room for additional electronics and/or increased area for the light-emitting element. In a bottom-emitting display device (i.e., a device that emits light through the substrate), this embodiment preferably allows the light-emitting area to be increased, thereby lowering the required current density to the light-emitting materials and increasing the lifetime of the display device. Although the at least one additional light-emitting element may be comprised of any color of light-emitting element that has a higher efficiency than at least one of the red, green, or blue light-emitting elements, it will typically preferably be chosen from among white, cyan, yellow, or magenta light-emitting elements.

A detailed embodiment of a portion of a display device useful in practicing this invention is shown in FIG. 3. A portion of a display substrate 40 comprised of red, green, blue and white light-emitting elements is shown, wherein the white light-emitting elements are higher in luminance efficiency than at least one of the red, green, or blue light-emitting elements. Each row, i.e., 42 and 44 of this display device is comprised of all colors of light-emitting elements. For example, the first row 42 of the portion of the display substrate 40 contains red 54, green 52, blue 56 and white 58 light-emitting elements. Additionally, each pair 60 and 62 of columns 61, 63, 65, 67 of light-emitting elements is also comprised of all colors of light-emitting elements. For example, the first pair 60 of columns 61, 63 of light-emitting elements is comprised of green 52, red 54, blue 72, and white 74 light-emitting elements. Also shown in FIG. 3 each light-emitting element is driven by an active matrix circuit, including a select line 82, a data line 80, a select transistor 84, a capacitor 86, a power transistor 88, a power buss 90 and a capacitor line 89a. In this display device, a signal is provided on the select line 82, allowing a drive voltage provided on the data line 80 to charge the capacitor 86. When this capacitor is charged, the power transistor 88 allows current to flow from the power line 90 to a first electrode (not shown), which lies under the light-emitting element 52. The current flows from this electrode through the electro-luminescent material used to form the light-emitting element and to a second electrode above the light-emitting element (also not shown). As shown in this figure, the light-emitting elements in each pair of columns share a common buss. For example, the light-emitting elements (52, 54, 72, and 74) in the first pair 60 of columns, share a common buss 90. Further, the light-emitting elements (56, 58, 76, and 78) in a neighboring pair 62 of columns 65, 67, share a separate, common buss 92.

While FIG. 3 provides a specific configuration of active matrix drive circuitry, several variations of conventional circuits can also be applied to the present invention by those skilled in the art. For instance, the location of the power busses 90 and 92 can be interchanged with capacitor lines 89a and 89b allowing the power lines to provide power to one or even two rows of light-emitting elements.

Another configuration of the drive circuitry, which is described in U.S. Pat. No. 5,550,066, connects the capacitor 86 directly to the power buss 90 instead of a separate capacitor line. A variation in U.S. Pat. No. 6,476,419 uses two capacitors disposed directly over one and another, wherein the first capacitor is fabricated between a semiconductor layer and a gate conductor layer that forms conductor for the gate of one of the TFTs, and the second capacitor is fabricated between the gate conductor layer and a second conductor layer that forms the power buss 90 and data lines 80.

While the drive circuitry described herein requires a select transistor 84 and a power transistor 88, several variations of these transistor designs are known in the art. For example, single- and multi-gate versions of transistors are known and have been applied to select transistors in prior art. A single-gate transistor includes a gate, a source and a drain. An example of the use of a single-gate type of transistor for the select transistor is shown in U.S. Pat. No. 6,429,599. A multi-gate transistor includes at least two gates electrically connected together and therefore a source, a drain, and at least one intermediate source-drain between the gates. An example of the use of a multi-gate type of transistor for the select transistor is shown in U.S. Pat. No. 6,476,419. This type of transistor can be represented in a circuit schematic by a single transistor or by two or more transistors in series in which the gates are connected and the source of one transistor is connected directly to the drain of the next transistor. While the performance of these designs can differ, both types of transistors serve the same function in the circuit and either type can be applied to the present invention by those skilled in the art. The example of the preferred embodiment of the present invention is shown with a multi-gate type select transistor 84.

Also known in the art is the use multiple parallel transistors, which are typically applied to the power transistor 88. Multiple parallel transistors are described in U.S. Pat. No. 6,501,448. Multiple parallel transistors consist of two or more transistors in which their sources are connected together, their drains are connected together, and their gates are connected together. The multiple transistors are separated within the light-emitting elements so as to provide multiple parallel paths for current flow. The use of multiple parallel transistors has the advantage of providing robustness against variability and defects in the semiconductor layer manufacturing process. While the power transistors described in the various embodiments of the present invention are shown as single transistors, multiple parallel transistors can be used by those skilled in the art and are understood to be within the spirit of the invention.

FIG. 4 shows a cross section of one light-emitting element within a bottom-emitting embodiment of such a display. The device including the drive circuitry and the organic EL media 110 are formed on substrate 112. Many materials can be used for substrate 112 such as, for example, glass and plastic. The substrate may be further covered with one or more barrier layers (not shown). If the device is to be operated such that light generated by the light-emitting elements is viewed through the substrate, the substrate should be transparent. This configuration is known as a bottom-emitting device. In this case, materials for the substrate such as glass or transparent plastics are preferred. The aperture ratio of the light-emitting element is particularly important in a bottom-emitting configuration and the improvement of the aperture ratio of the light-emitting elements is a significant advantage of the present invention. This invention may also be utilized in top-emitting display devices, however, wherein the light is emitted away from the substrate. Under these conditions, the substrate may be glass or plastic but may also be formed from opaque materials, such as stainless steel with an insulating layer.

Above the substrate 112, a first semiconductor layer is provided, from which semiconductor region 94 is formed. Above semiconductor region 94, first dielectric layer 114 is formed and patterned by methods such as photolithography and etching. This dielectric layer is preferably silicon dioxide, silicon nitride, or a combination thereof. It may also be formed from several sub-layers of dielectric material. Above first dielectric layer 114, a first conductor layer is provided, from which power transistor gate 108 is formed and patterned by methods such as photolithography and etching. This conductor layer can be, for example, a metal such as Cr, as is known in the art. Above power transistor gate 108, a second dielectric layer 116 is formed. This dielectric layer can be, for example, silicon dioxide, silicon nitride, or a combination thereof. Above second dielectric layer 116, a second conductor layer is provided, from which power buss 90 and data line 80 are formed and patterned by methods such as photolithography and etching. This conductor layer can be, for example, a metal such as an Al alloy as is known in the art. Power buss 90 makes electrical contact with semiconductor region 92 through a via opened in the dielectric layers. Over the second conductor layer, a third dielectric layer 118 is formed.

Above the third dielectric layer, a first electrode 96 is formed. First electrode 96 is preferably highly transparent for the case of a bottom-emitting configuration and may be constructed of a material such as ITO. Above first electrode 96, an inter-subpixel dielectric 120 layer, such as is described in U.S. Pat. No. 6,246,179, is preferably used to cover the edges of the first electrodes in order to prevent shorts or strong electric fields in this area. While use of the inter-subpixel dielectric 120 layer is preferred, it is not required for successful implementation of the present invention. The area of the first electrode 96 not covered by inter-subpixel dielectric 120 constitutes the light-emitting area.

Each of the light-emitting elements further includes an EL media 110. There are numerous configurations of the EL media 110 layers wherein the present invention can be successfully practiced. For example, the EL media may be an organic EL media. For the organic EL media, a broadband or white light source, which emits light at the wavelengths used by all the light-emitting elements, may be used to avoid the need for patterning the organic EL media between light-emitting elements. In this case, color filters (not shown) may be provided for some of the light-emitting elements in the path of the light to produce the desired light colors from the white or broadband emission for a multi-color display. It should be noted that in this configuration, the filters applied to the red, green, and blue light-emitting elements will typically absorb more light than broader bandwidth filters that can be used to form cyan, yellow, or magenta light-emitting elements and certainly will absorb more light than would be absorbed in the absence of a filter. Therefore, in these configurations, it is highly likely that the additional light-emitting elements will have efficiencies that are greater than at least one, if not all three, of the red, green, and blue light-emitting elements. Some examples of organic EL media layers that emit broadband or white light are described, for example, in U.S. Pat. No. 6,696,177B1. However, the present invention can also be made to work where each light-emitting elements has one or more of the organic EL media layers separately patterned for each light-emitting elements to emit differing colors for specific light-emitting elements. The EL media 110 may be constructed of several organic layers such as; a hole injecting layer 122, a hole transporting layer 124 that is disposed over the hole injecting layer 122, a light-emitting layer 126 disposed over the hole transporting layer 124, and an electron transporting layer 128 disposed over the light-emitting layer 126. Alternate constructions of the organic EL media 110 having fewer or more layers can also be used to successfully practice the present invention. These organic EL media layers are typically comprised of organic materials, either small molecule or polymer materials, as is known in the art. These organic EL media layers can be deposited by several methods known in the art such as, for example, thermal evaporation in a vacuum chamber, laser transfer from a donor substrate, or deposition from a solvent by use of an ink jet print apparatus.

Above the EL media 110, a second electrode 130 is formed. For a bottom emitting device, this electrode is preferably highly reflective and may be composed of a metal such as aluminum or silver or magnesium silver alloy. The second electrode may also comprise an electron injecting layer (not shown) composed of a material such as lithium to aid in the injection of electrons. When stimulated by an electrical current between first electrode 96 and second electrode 130, the organic EL media 110 produces light emission 132.

Most OLED devices are sensitive to moisture or oxygen, or both, so they are commonly sealed in an inert atmosphere such as nitrogen or argon, along with a desiccant such as alumina, bauxite, calcium sulfate, clays, silica gel, zeolites, alkaline metal oxides, alkaline earth metal oxides, sulfates, or metal halides and perchlorates. Methods for encapsulation and desiccation include, but are not limited to, those described in U.S. Pat. No. 6,226,890. In addition, barrier layers such as SiOx, Teflon, and alternating inorganic/polymeric layers are known in the art for encapsulation.

EL devices of this invention can employ various well-known optical effects in order to enhance the displays properties if desired. This includes but is not limited to optimizing layer thicknesses to yield maximum light transmission, providing dielectric mirror structures, replacing reflective electrodes with light-absorbing electrodes, providing light scattering layers to enhance light extraction, providing anti-glare or anti-reflection coatings over the display, providing a polarizing media over the display, or providing colored, neutral density, or color conversion filters over the display.

The current invention requires that a display such as described in FIG. 3 and FIG. 4, be provided in a system. FIG. 5 depicts the system of the present invention. As shown in FIG. 5, the system is comprised of a controller 412 and a display 410. Within this system, the controller will receive an input signal, which will generally represent each spatial location with a full-color signal. This color signal may be a RGB signal or it may have a different encoding, such as a luma-chroma encoding. This data will generally be clocked into the controller such that data representing information to be presented in the top left of the display will be transmitted first, followed by information to be presented horizontally across the display, followed subsequently by the data for the beginning of a second horizontal scan across the display, and so forth. As such, it will be necessary for the controller to store information into some form of a memory buffer to gain access to the two-dimensional information that is necessary to perform the functions that are necessary to enable the system of the invention. Therefore, this controller will receive this signal, buffer at least a portion of the signal, transform the signal to a signal for driving the display, and transmit a transformed signal to the display 410. In a preferred embodiment, the controller will buffer at least one line of data. However, in a further preferred embodiment, the controller will buffer four lines and four pixels of data and then begin processing the data in real-time such that a value is provided to the display after only a slight initial delay. However, it will be recognized that to practice this invention the controller will need access to data representing a spatial location that is horizontally displaced and data representing a spatial location that is vertically displaced from the one that is being processed and preferably, the controller will have access to data for one or two spatial locations that are displaced from the current light-emitting element in all directions.

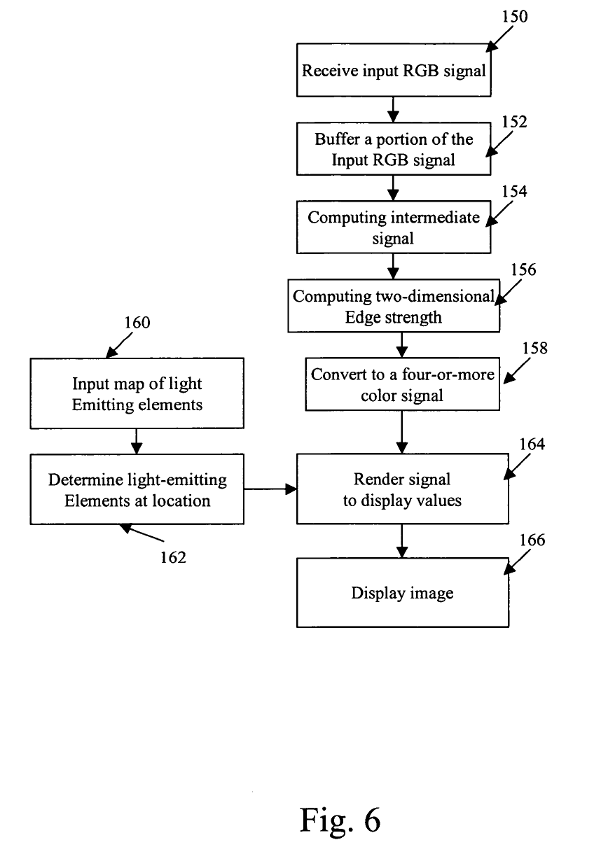

Although, the controller 412 may utilize many different processes to achieve the present invention, this controller will preferably perform the steps as shown in FIG. 6. As shown, the controller will receive 150 an input RGB signal and buffer 152 at least a portion of this signal. Note that the number of spatial locations that are represented in the signal (i.e., the signal addressability) will preferably be larger than the number of any color of light-emitting element on the display device. For example, when displaying an image on the display device depicted in FIG. 3, the number of addressable spatial locations in the signal will preferably be at least one half the number of light-emitting elements within the display device, rather than one fourth of the number of light-emitting elements as is typically taught within the art for a display having four colors of light-emitting elements. The controller will then compute 154 an intermediate signal that is indicative of the luminance output that might be provided by the one or more additional light-emitting elements. Although this computation 154 may take many forms, it may consist of transforming the input RGB values to linear intensity values as is known in the art, computing the RGB intensity values that are necessary to form the color of light that is output by one of the additional light-emitting elements, and then determining the minimum of the of these RGB intensity values. These steps have been described more fully in U.S. Pat. No. 6,885,380, the disclosure of which is hereby incorporated by reference, as steps for forming a white signal in an emissive display system having more than three colors of light-emitting elements. In a system having an additional primary that emits white light another potential intermediate metric is to compute the relative luminance. This value will generally be computed by computing a weighted average of the RGB values. For example, relative luminance might be computed summing 0.3 times the red value plus 0.586 times the green value plus 0.114 times the blue value.

Once the intermediate metric has been computed 154, two-dimensional filtering operations are performed given the current spatial location that is being operated on and at least one of its neighbors in the horizontal or vertical direction to compute 156 the two-dimensional edge strength of the intermediate signal. Although this may be accomplished through a number of means, one desirable method is to compute the ratio of a high pass filtered version of this intermediate signal to a low pass filtered version of the intermediate signal over a two-dimensional area. For example, given the intermediate value p(i,j), which represents the value of the intermediate signal at column i and row j within the image, this two-dimensional signal may be computed as:

$$f ( i , j ) = ( 1 / 9 ) * \frac{{\sum }_{k = i - 1}^{k = i + 1} ( {\sum }_{l = j - 1}^{l = j + 1} ( p ( i , j ) - p ( k , l ) ) )}{{\sum }_{k = i - 1}^{k = i + 1} ( {\sum }_{l = j - 1}^{l = j + 1} ( p ( i , j ) + p ( k , l ) ) )}$$

where f(i, j) represents the two-dimensional edge strength, the numerator represents the high pass filter and the denominator represents the low pass filter and the factor 1/9 normalizes the resulting values between 0 and 1.

Once the two-dimensional edge strength is computed 156, this edge strength is used to convert 158 the three color input signal to a four-or-more color signal. This computation will typically involve the subtraction of a proportion of energy from the three color input signal and addition of this energy to the one or more additional color channels such that a larger proportion of this energy is moved to the additional color channels when the edge strength is low than when the edge strength is high. As a specific example, returning to step 154, recall that the input three color signal RGB values were converted to linear intensity and then these linear intensity values were normalized to the color of the additional light-emitting element. Returning to these normalized linear intensity values, and the minimum of these values that were computed in step 154, we may compute the normalized output RGB values as
Rₙ(i,j)=Rᵢ(i,j)−a(i,j)*min(Rᵢ(i,j), Gᵢ(i,j), Bᵢ(i,j)), (eqn. 1)
Gₙ(i,j)=Gᵢ(i,j)−a(i,j)*min(Rᵢ(i,j), Gᵢ(i,j), Bᵢ(i,j)), (eqn. 2)
Bₙ(i,j)=Bᵢ(i,j)−a(i,j)*min(Rᵢ(i,j), Gᵢ(i,j), Bᵢ(i,j)) (eqn. 3)

where Rₙ(i,j), Gₙ(i,j), Bₙ(i,j) represent the normalized output values, the values Rᵢ(i,j), Gᵢ(i,j), and Bᵢ(i,j) represent the normalized linear intensity values that were computed from the input signal, and min(Rᵢ(i,j), Gᵢ(i,j), Bᵢ(i,j)) represents the minimum of the normalized linear intensity values. The signal for the additional color channel is then computed as:
Wₙ(i,j)=b(i,j)*min(Rᵢ(i,j), Gᵢ(i,j), Bᵢ(i,j)) (eqn. 4)

where Wₙ(i,j) is the normalized signal for the additional color channel. Note that each of these equations contain the values a(i,j) or b(i,j). In the current embodiment of the present invention a(i,j) and b(i,j) are not constants but instead are functions of the two-dimensional edge strength f(i,j). A simple function that can be employed with success is to compute a(i,j) and b(i,j) as 0.5*(1−f(i,j)). Using this calculation, a white light-emitting element on a black and white edge produce about half the luminance while on the bright side of the edge while the R, G, and B light-emitting elements will produce the remainder. Note that to maintain color accuracy a(i,j) and b(i,j) will be equal but this is not necessary and, in fact, under some circumstances it may be desirable for b(i,j) to have a higher slope than a(i,j). Within this particular implementation, when presenting flat white areas within the scene, the white light-emitting element will produce all of the luminance but the red, green, and blue light-emitting elements will be activated near edge boundaries, even when rendering a black and white scene. Modifications to this process may be made, one such modification is to filter or smooth the edge strength f(i,j) before computing the values of a(i,j) or b(i,j). Finally the weighting of the RGB signals may be modified to normalize them to the white point of the display, thus completing the conversion of the three color input signal to the more than three color signal. If there are more than four colors of light-emitting elements, other modifications may be made to this image-processing path. In one implementation, each additional light-emitting element is added to the path one at a time. A step is added between each iteration of the conversion wherein it is determined where in color space each additional light-emitting element lies with respect to the light-emitting elements for which a signal has been computed. Generally, the location of this element will lie within one of the resulting triangles (i.e., subgamuts) formed by the previously added additional light-emitting elements and two of the red, green, and blue light-emitting elements, in subsequent cycles, the three light-emitting elements whose colors define the subgamut in which the additional light-emitting element lies are used in place of the RGB input signals. This process was also described in more detail within U.S. Pat. No. 6,885,380.

It might be noted that one important aspect of the conversion equations 1 through 4 is that luminance is subtracted from the red, green, and blue normalized linear intensity values when forming the information for the one or more light-emitting elements and that the value of b(i,j) is not significantly larger than a(i,j) as this has the implication all of the light-emitting elements will not be driven to their peak luminance simultaneously, and, therefore, the current that must be provided by any power buss that provides energy to all colors of light-emitting elements is less than the peak current that would be provided if all four light-emitting elements were simultaneously driven to their maximum values. Therefore, a controller employing these equations will drive the light-emitting elements of the display device in combination to reduce the total instantaneous current requirements of the busses by controlling the light emissive elements such that the luminance produced by at least one of the light-emitting elements, when all colors of light-emitting elements are employed simultaneously, is lower than the luminance that is produced by the same light-emitting element when the color of light that is being displayed is approximately equal to the color of the light-emitting element. This behavior reduces the peak current that each buss is required to provide, thereby decreasing the required size of the buss and reducing the area required for drive electronics. In a bottom emitting display device, this increases the area available for light emission and in a top emitting display device, this can allow the designer to increase the addressability of the display device.

Once the four-or-more color signal has been formed 158, it is then necessary to render the output values to drive the display. However, because the arrangement of light-emitting elements on the display varies as a function of spatial location, an input map of the light-emitting elements must be input 160. This map is used to determine 162 the color of light-emitting elements for each addressable data point within the converted four-or-more color image signal. Once the colors of the light-emitting elements are determined 162, the converted four-or-more color signal is rendered by down converting 164 to the array of light-emitting elements on the display. For example, referring again to FIG. 3, a spatial location within the four-or-more color signal may correspond to the location on the display comprised of green 52 and red 54 light-emitting elements. For this location, the green and red values may be rendered from the converted four-or-more color signal. These values may be used to drive these light-emitting elements or they may be a weighted fraction of their neighbors. In one embodiment, the current values of the red and green light-emitting elements may be computed as a weighted average of the values at the current location within the converted more than three color signal, wherein the red and green data values at the current location within the signal are weighted equally to the sum of the four neighboring red and green values for which the display does not have light-emitting elements. That is, the value for the green light-emitting element may be computed from:

$${G}_{o} ( i , j ) = \frac{( \begin{matrix}4 G ( i , j ) + G ( ( i - 1 ) , j ) + G ( ( i + 1 ) , j ) + \\ G ( i , ( j - 1 ) ) + G ( i , ( j + 1 ) )\end{matrix} )}{8} \qquad ( eqn . 5 )$$

Where Gₒ(i,j) represents the rendered green value for the light-emitting elements at (i,j) where i represents the number of light-emitting elements from the top of the display, j represents the number of rows of light-emitting elements divided by 2 and G(i,j) represents the converted more than color image signal at input addressable element location (i,j).

A fully digital converter would perform this digital down conversion rendering in total. However, the controller may also have analog outputs. In such systems, while down conversion rendering would typically be performed along both dimensions, the down conversion must only be performed in the vertical direction. Horizontal down conversion will be accomplished as the timing controller selects the voltage in the analog signal to be loaded onto the data line 80 of the display device.

As noted earlier, when such a controller is used in conjunction with a display of the present invention, the controller will receive an input signal for an input image having a two-dimensional spatial content including edge boundaries between first and second regions of the input image and driving the display and then being responsive to the two-dimensional spatial content of the input image, the controller will render the input image signal such that when the additional light-emitting elements are driven at different levels in the first and second regions of the input image, utilization of the light-emitting elements is adjusted such that the ratio of the sum of the luminance values of the red, green, blue light-emitting elements to the sum of the luminance values of the additional light-emitting elements along an edge boundary in at least one of the first and second regions is closer to one than the ratio of the sum of the luminance values of the red, green, blue light-emitting elements to the sum of the luminance values of the additional light-emitting elements within the interior of at least one of the first and second regions within the displayed image. This is depicted in FIG. 7, which shows a portion of such a display containing a displayed image. As shown in this figure, the image is comprised of the first region 170, which is a white background. On this background is a pentagon, which represents the second region 172. As shown in this figure, within areas of the first region that are remote from the second region, the light-emitting elements are rendered so that practically all luminance is produced by the white light-emitting elements. Therefore, the ratio of the luminance of the sum of the red, green and blue light-emitting elements to the sum of the luminance of the luminance of the red, green, and blue light-emitting elements is approximately zero within the first region. However, near the boundary 174 of the first 170 and second 172 regions, the light-emitting elements are rendered so that the red, green, and blue light-emitting elements are employed to improve the smoothness of the edge between the two regions and to thereby improve the perceived resolution of the display device. In fact, in the area near the boundary 174, the ratio of the sum of the luminance values for the red, green, and blue light-emitting elements is approximately equal to the luminance value of the additional white light-emitting element.

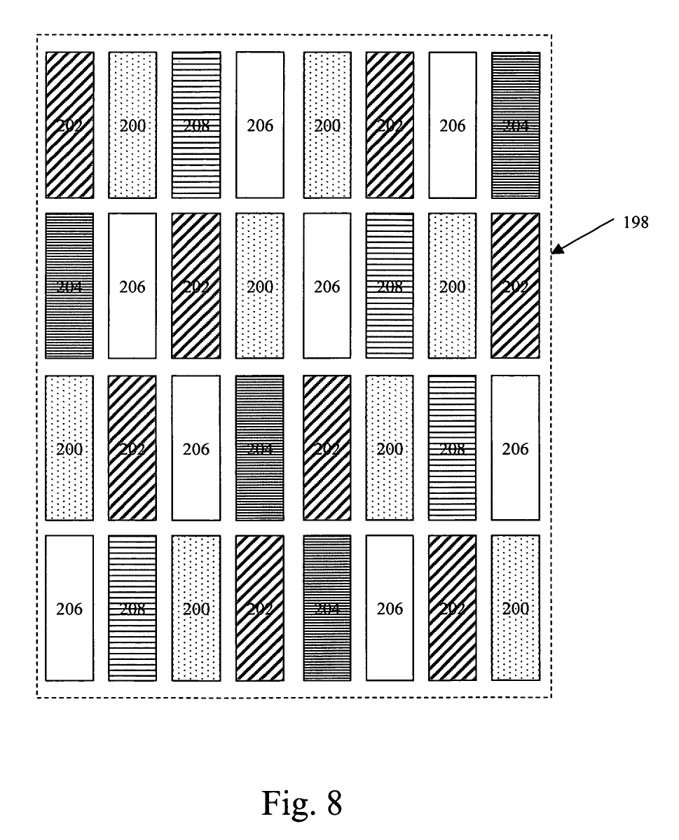

Although this disclosure provides an overview of the current invention, many modifications may be made that are within the scope of this invention. For example, there are many other arrangements of light-emitting elements for which this invention may be applied. FIG. 8 shows a portion of a display 198 having one more such arrangement of light-emitting elements, including red 200, green 202, blue 204, white 206 and cyan 208 light-emitting elements, wherein the white 206 and the cyan 208 light-emitting elements have a higher luminance efficiency than at least one of the red 202, green 200, or blue 206 light-emitting elements. As was the case for FIG. 3, each horizontal row and each pair of vertical columns of light-emitting elements contain all five colors of light-emitting elements.

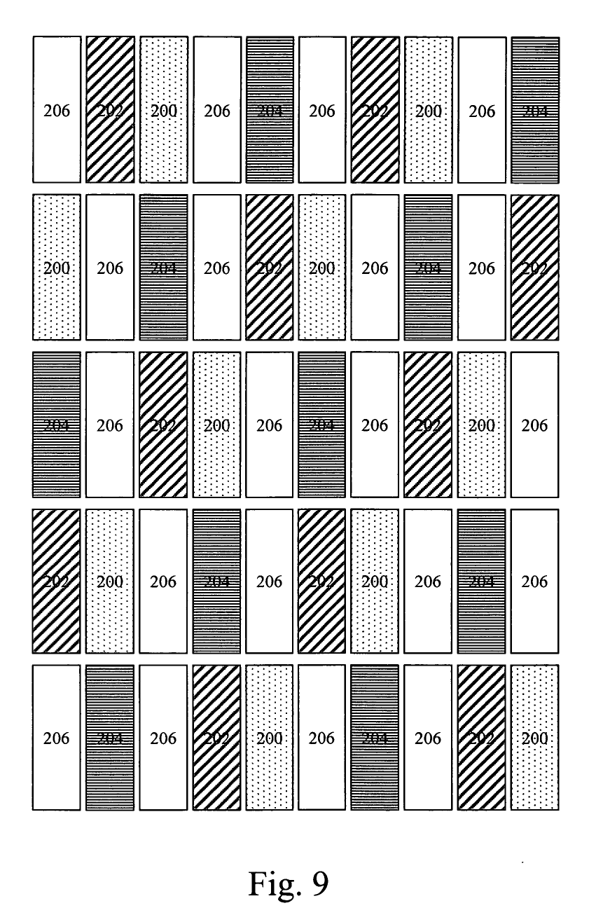

FIG. 9 depicts an additional arrangement of red, green, blue and white light-emitting elements, wherein the white 206 light-emitting elements are higher in luminance efficiency than at least one of the red 200, green 204 or blue 206 light-emitting elements. Although this arrangement of light-emitting elements contain the same colors of light-emitting elements as the arrangement depicted in FIG. 3 and each horizontal row and each pair of vertical columns of light-emitting elements contain all colors of light-emitting elements, this arrangement of light-emitting elements contains more white 206 light-emitting elements than red 200, green 202, or blue 204 light-emitting elements. Further, while the light-emitting elements shown in either of these figures and other figures throughout this disclosure are approximately equal in size, this is not required and the different color of light-emitting elements may be different in size. Further, any of these arrangements may contain unequal numbers of any color of light-emitting elements. However, it is likely that any arrangement of red, green, blue, and white light-emitting elements will contain more area of white light-emitting elements as these light-emitting elements will be used more often than the red, green, or blue light-emitting elements in most application and therefore, they will form a larger area of the display to balance the lifetime of the display device. Further, while the light-emitting elements are all depicted as being about twice as long in one dimension (i.e., the first dimension) than a second dimension, this is not required and the light-emitting elements may have any shape, including having a square shape.

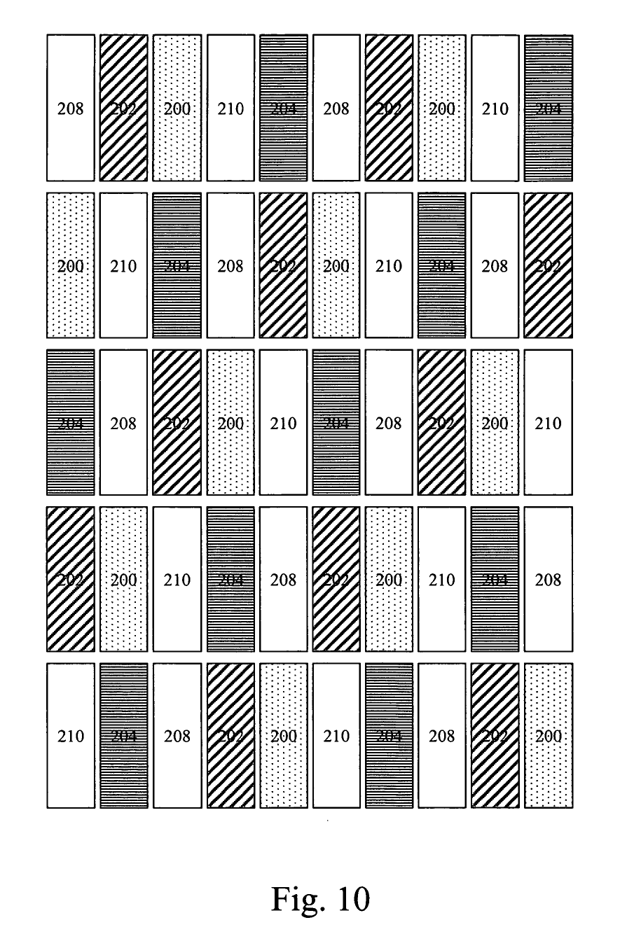

FIG. 10 depicts yet an additional arrangement of light-emitting elements, including red 200, green 202, blue 204, cyan 208 and yellow 210 light-emitting elements, wherein at the cyan 208 and yellow 210 light-emitting elements are higher in luminance efficiency than at least one and more preferably all three of the red 200, green 202, and blue 204 light-emitting elements. As in each of the embodiments each horizontal row and each pair of vertical columns of light-emitting elements contain all colors of light-emitting elements. It should be noted that in most applications, it is necessary to balance the lifetime of the emitters. For this reason, having additional yellow and cyan light-emitting elements can offset any color bias that the other introduces. Further, in systems employing color filters, it is highly desirable to add an unfiltered light-emitting element. Therefore, while many displays having five colors of light-emitting elements as shown in FIG. 10 may be desirable, it is most desirable to add combinations of yellow and cyan; white and yellow; or white and cyan to the red, green, and blue light-emitting elements to form a display having five colors of light-emitting elements.

Although this disclosure has been primarily described in detail with particular reference to OLED displays, images may be rendered for a variety of other types of displays using the present invention, including liquid crystal displays and plasma displays. Certain embodiments directed towards use of displays comprising a more efficient additional colored light-emitting element will be particularly applicable for use with OLED or other types of EL display devices that produce light as a function of the current provided to the light-emitting elements of the display. For example, such embodiment may also apply to electro-luminescent display devices employing coatable inorganic materials, such as described by Mattoussi et al. in the paper entitled “Electroluminescence from heterostructures of poly(phenylene vinylene) and inorganic CdSe nanocrystals” as described in the Journal of Applied Physics Vol. 83, No. 12 on Jun. 15, 1998, or to displays formed from other combinations of organic and inorganic materials which exhibit electro-luminescence.

The invention has been described in detail with particular reference to certain preferred embodiments thereof, but it will be understood that variations and modifications can be effected within the spirit and scope of the invention.

### PARTS LIST

2 luminance contrast threshold curve
4 red/green chrominance threshold curve
6 blue/yellow chrominance threshold curve
10 display
12 high-luminance subpixel
14 red subpixel
16 green subpixel
18 blue subpixel
40 display substrate portion
42 first row
44 second row
52, 76 green light-emitting elements
54, 78 red light-emitting elements
56, 72 blue light-emitting elements
58, 74 white light-emitting elements
60 first pair of columns
61, 63, 65, 67 column of light-emitting elements
62 second pair of columns
80 data line
82 select line
84 select transistor
86 capacitor
88 power transistor
89a capacitor line
89b capacitor line
90 power bus
92 power bus
94 semiconductor region
96 first electrode
108 power transistor gate
110 EL media
112 substrate
114 first dielectric layer
116 second dielectric layer
118 third dielectric layer
120 inter-subpixel dielectric layer
122 hole-injecting layer
124 hole-transporting layer
126 light-emitting layer
128 electron-transporting layer
130 second electrode
132 light emission
150 receiving step
152 buffering step
154 compute intermediate signal step
156 compute two-dimensional edge strength step
158 convert to four-or-more color signal step
160 input locations of light-emitting elements step
162 determine light-emitting elements step
164 render step
170 first region
172 second region
174 boundary
198 display portion
200 red light-emitting element
202 green light-emitting element
204 blue light-emitting element
206 white light-emitting element
208 cyan light-emitting element
210 yellow light-emitting element
300 Obtain image step
305 Provide display step
310 Provide algorithms step
315 Analyze image step
320 Determine rendering computation step
325 Render image step
330 Display rendered image step
410 display
412 controller
414 image signal
416 rendered image signal
420, 428, 428′, 429 light-emitting element
500 spatial location represented in the input image signal
502 row of spatial locations
504 column of spatial locations

1. A method for rendering a full-color image onto an image display device, comprising the steps of:
a) obtaining a full-color input image signal representing three or more spatially coincident color values at a plurality of different spatial locations in a two-dimensional image array;
b) providing a display having a plurality of at least two colors of spatially distinct light-emitting elements arranged within a two-dimensional display array;
c) providing a plurality of different rendering computations, each rendering computation capable of computing a different display drive signal value for each of the plurality of light-emitting elements depending on the color values of the full-color input image signal at two or more different spatial locations and depending on differences in the color, location, or number of light-emitting elements in the display array relative to the color, location or number of color values in the image array;
d) analyzing the spatial content of the full-color input image signal to select a preferred rendering computation or combination of rendering computations from among the plurality of different rendering computations for each light-emitting element;
e) employing the preferred rendering computation or combination of rendering computations to form a rendered image display drive signal, the rendered image drive signal defining a value for driving each of the light-emitting elements within the two-dimensional display array; and
f) displaying the rendered image on the image display.

2. The method of claim 1 wherein the colors of spatially distinct light-emitting elements comprise red, green, and blue.

3. The method of claim 1 wherein the colors of spatially distinct light-emitting elements comprise at least four colors.

4. The method of claim 3 wherein the colors of spatially distinct light-emitting elements comprise red, green, and blue light-emitting elements and at least one of a second green, a yellow, a cyan, a magenta, or a white light-emitting element.

5. The method of claim 1 wherein two spatially distinct neighboring light-emitting elements are arranged to form a spatial arrangement that is substantially square, and neighboring substantially square spatial arrangements of light-emitting elements comprise different colors of light-emitting elements.

6. The method of claim 1 wherein the light-emitting elements are arranged substantially into rows and columns and wherein at least one of the rows or columns contain all colors of light-emitting elements and wherein multiple colors of light-emitting elements are also present within the orthogonal rows or columns.

7. The method of claim 1 wherein the number of spatial locations within the full-color input image signal is larger than the number of spatial locations for at least one of the colors of light-emitting elements within the display.

8. The method of claim 1 wherein the number of spatial locations within the full-color input image signal is larger than the number of spatial locations for each color of light-emitting elements within the display.

9. The method of claim 1, wherein analyzing includes analyzing the two-dimensional spatial content of the full-color input image signal.

10. The method of claim 1, wherein analyzing includes determining whether each spatial location of the full-color input image signal forms part of a flat field, a luminance and/or a chrominance edge defining first and second image areas having a distinctive difference in luminance or chrominance, a portion of a luminance and/or a chrominance line separating first and second image areas, or a random field having a range of output values.

11. The method of claim 10, wherein the preferred rendering computation provides a different rendering for light-emitting elements in the vicinity of an edge between first and second image areas than for light-emitting elements in at least one of the first or second image areas.

12. The method of claim 11, wherein the preferred rendering computation provides a different rendering for light-emitting elements in the vicinity of a horizontal, a vertical, or a diagonal edge.

13. The method of claim 1 1, wherein the colors of spatially distinct light-emitting elements include at least three different colors and an additional color within the gamut defined by the three different colors, and the additional color light-emitting element is more energy efficient than at least one of the gamut-defining light-emitting elements,
and wherein the preferred rendering computation adjusts the ratio of the sum of the luminance values of the gamut-defining color light-emitting elements to the sum of the luminance values of the additional light-emitting elements for light-emitting elements in the vicinity of an edge between first and second image areas such that the ratio is closer to one than the ratio of the sum of the luminance values of the gamut-defining color light-emitting elements to the sum of the luminance values of the additional light-emitting elements for light-emitting elements within the interior of at least one of the first and second image areas within the displayed image, thereby increasing apparent display resolution while providing increased display power efficiency.

14. The method of claim 10, wherein the preferred rendering computation provides a different rendering for light-emitting elements in a line separating first and second image areas than the rendering for light-emitting elements in the first or second image areas.

15. The method of claim 1, wherein the full-color image signal is transformed into an image signal having a luminance component and a plurality of color components prior to rendering.

16. A display device comprising:
a plurality of at least two colors of spatially distinct light-emitting elements arranged within a two-dimensional display array; and
a controller (i) responsive to a full-color input image signal representing three or more spatially coincident color values at a plurality of different spatial locations in a two-dimensional image array, for providing a plurality of different rendering computations, each rendering computation capable of computing a different display drive signal value for each of the plurality of light-emitting elements depending on the color values of the full-color input image signal at two or more different spatial locations and depending on differences in the color, location, or number of light-emitting elements in the display array relative to the color, location or number of color values in the image array, (ii) for analyzing the spatial content of the full-color input image signal to select a preferred rendering computation or combination of rendering computations from among the plurality of different rendering computations for each light-emitting element, (iii) for employing the preferred rendering computation or combination of rendering computations to form a rendered image display drive signal, the rendered image drive signal defining a value for driving each of the light-emitting elements within the two-dimensional display array, and (iv) for driving the light-emitting elements to display the rendered image on the image display.

17. A display device according to claim 16, wherein the light-emitting elements are arranged in groups forming a repeating two-by-two array of light-emitting elements.

18. A display device according to claim 16, wherein the colors of spatially distinct light-emitting elements include at least three different colors and an additional color within the gamut defined by the three different colors, and the additional color light-emitting element is more energy efficient than at least one of the gamut-defining light-emitting elements, and wherein the controller adjusts the ratio of the sum of the luminance values of the gamut-defining color light-emitting elements to the sum of the luminance values of the additional light-emitting elements for light-emitting elements in the vicinity of an edge between first and second image areas such that the ratio is closer to one than the ratio of the sum of the luminance values of the gamut-defining color light-emitting elements to the sum of the luminance values of the additional light-emitting elements for light-emitting elements within the interior of at least one of the first and second image areas within the displayed image, thereby increasing apparent display resolution while providing increased display power efficiency.

19. The display device of claim 18, additionally comprising an active matrix circuit wherein power is provided by an array of electrical buses and wherein one or more of the electrical buses provide current to each color of light-emitting elements within the display device.

20. The display device of claim 19, wherein the controller drives the light-emitting elements of the display device in combination to reduce the total current requirements of the buses by controlling the light-emissive elements such that the luminance produced by at least one of the light-emitting elements, when all colors of light-emitting elements are employed simultaneously, is lower than the luminance that is produced by the same light-emitting element when the color of light that is being displayed is approximately equal to the color of the light-emitting element, reducing the peak current that each bus is required to provide.
